(19) United States
(12) Patent Application Publication
(10) Pub. No.: US 2026/0313652 A1
(43) Pub. Date: Oct. 8, 2026

(54) PHYSICAL UPLINK CONTROL CHANNEL SEQUENCE SWITCHING BASED ON NETWORK CONFIGURATIONS

(71) Applicant: QUALCOMM Incorporated, San Diego, CA (US)

(72) Inventors: Akash Sandeep DOSHI, San Diego, CA (US); June NAMGOONG, San Diego, CA (US); Wei YANG, San Diego, CA (US); Yi HUANG, San Diego, CA (US)

(21) Appl. No.: 19/632,056

(22) Filed: Mar. 27, 2026

Related U.S. Application Data
(60) Provisional application No. 63/782,400, filed on Apr. 2, 2025.

(51) Int. Cl. H04W 72/21; H04L 5/14; H04L 41/16

(52) U.S. Cl. CPC H04W 72/21; H04L 5/14; H04L 41/16

(57) ABSTRACT

This disclosure provides methods, components, devices and systems for wireless communications. For example, a user equipment (UE) may to determine a codebook to use for physical uplink control channel (PUCCH) transmissions based on network configurations. For example, the network entity may transmit a PUCCH codebook identifier (ID) to the UE based on a configuration of the network entity. The PUCCH codebook ID may indicate for the UE to use a single-port codebook, a multi-port codebook, a discrete Fourier transform (DTF) codebook, or a look-up table (LUT). In some examples, if the UE is not configured with the indicated PUCCH codebook, the UE may request the codebook associated with the PUCCH codebook ID from the network entity. The network entity may provide the codebook in response to the request.

### CROSS REFERENCE

The present Application for Patent claims the benefit of U.S. Provisional Patent Application No. 63/782,400 entitled “PHYSICAL UPLINK CONTROL CHANNEL SEQUENCE SWITCHING BASED ON NETWORK CONFIGURATIONS” to Doshi et al., filed on Apr. 2, 2025, which is assigned to the assignee hereof, and expressly incorporated by reference in its entirety herein.

### TECHNICAL FIELD

This disclosure relates generally to wireless communication, and more specifically to systems, devices, methods, and techniques associated with physical uplink control channel sequence switching based on network configurations.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a UE is described. The method may include wirelessly receiving control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly transmitting the PUCCH message generated in accordance with a first PUCCH sequence of the set of multiple PUCCH sequences of the first PUCCH codebook.

A UE for wireless communication is described. The UE may include a processing system that includes processor circuitry and memory circuitry that stores code. The processing system may be configured to cause the UE to wirelessly receive control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly transmit the PUCCH message generated in accordance with a first PUCCH sequence of the set of multiple PUCCH sequences of the first PUCCH codebook.

Another UE for wireless communication is described. The UE may include means for wirelessly receiving control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and means for wirelessly transmitting the PUCCH message generated in accordance with a first PUCCH sequence of the set of multiple PUCCH sequences of the first PUCCH codebook.

A non-transitory computer-readable medium storing code for wireless communication is described. The code may include instructions executable by one or more processors to wirelessly receive control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly transmit the PUCCH message generated in accordance with a first PUCCH sequence of the set of multiple PUCCH sequences of the first PUCCH codebook.

Some examples of the method, user equipments, and non-transitory computer-readable medium described herein may further include operations, features, means, or instructions for wirelessly transmitting a request for the first PUCCH codebook based on reception of the codebook identifier and wirelessly receiving the first PUCCH codebook in response to the request.

A method for wireless communication by a network entity is described. The method may include wirelessly transmitting control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly receiving the PUCCH message generated in accordance with a first PUCCH sequence of the set of multiple PUCCH sequences of the first PUCCH codebook.

A network entity for wireless communication is described. The network entity may include a processing system that includes processor circuitry and memory circuitry that stores code. The processing system may be configured to cause the network entity to wirelessly transmit control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly receive the PUCCH message generated in accordance with a first PUCCH sequence of the set of multiple PUCCH sequences of the first PUCCH codebook.

Another network entity for wireless communication is described. The network entity may include means for wirelessly transmitting control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and means for wirelessly receiving the PUCCH message generated in accordance with a first PUCCH sequence of the set of multiple PUCCH sequences of the first PUCCH codebook.

A non-transitory computer-readable medium storing code for wireless communication is described. The code may include instructions executable by one or more processors to wirelessly transmit control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences and wirelessly receive the PUCCH message generated in accordance with a first PUCCH sequence of the set of multiple PUCCH sequences of the first PUCCH codebook.

Some examples of the method, network entities, and non-transitory computer-readable medium described herein may further include operations, features, means, or instructions for wirelessly receiving a request for the first PUCCH codebook based on the codebook identifier and wirelessly transmitting the first PUCCH codebook in response to the request.

### BRIEF DESCRIPTION OF THE DRAWINGS

FIG. 1 shows an example of a wireless communication system.

FIG. 2 shows an example of a signaling configuration that supports physical uplink control channel (PUCCH) sequence switching based on network configurations.

FIG. 3 shows an example of a process flow that supports PUCCH sequence switching based on network configurations.

FIG. 4 shows a block diagram of a processing system that supports PUCCH sequence switching based on network configurations.

FIG. 5 shows a diagram of a system including a device that supports PUCCH sequence switching based on network configurations.

FIG. 6 shows a block diagram of a processing system that supports PUCCH sequence switching based on network configurations.

FIG. 7 shows a diagram of a system including a device that supports PUCCH sequence switching based on network configurations.

FIGS. 8 through 11 show flowcharts illustrating methods that support PUCCH sequence switching based on network configurations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may wirelessly transmit a physical uplink control channel (PUCCH) message to a network entity. The PUCCH message may include a sequence that is cell-specific. That is, the PUCCH message may include a payload that is generated using a cell-specific sequence that may be orthogonal to one or more other PUCCH sequences. In some examples, transmission of the PUCCH message may be limited to a single antenna port at the UE, which may result in relatively less efficient use of communication resources in examples in which the UE has multiple antenna ports. For example, if the UE transmits the PUCCH message via multiple antenna ports, the UE may be unaware of whether to use a same PUCCH sequence (e.g., or a same codebook that provides a set of sequences) at each antenna port.

Aspects of the subject matter described in this disclosure relate to a UE that may to determine a codebook to use for PUCCH transmissions based on network configurations. For example, the network entity may transmit a PUCCH codebook identifier (ID) to the UE based on a configuration of the network entity. The PUCCH codebook ID may indicate for the UE to use a single-port codebook, a multi-port codebook, a discrete Fourier transform (DTF) codebook, or a look-up table (LUT) (e.g., an artificial intelligence (AI) or machine learning (ML)-based codebook). In some examples, if the UE is not configured with the indicated PUCCH codebook, the UE may request the codebook associated with the PUCCH codebook ID from the network entity or from a server. The network entity may provide the codebook in response to the request.

Particular aspects of the subject matter described in this disclosure can be implemented to realize one or more of the following potential advantages. In some examples, by selecting a PUCCH codebook in accordance with network configurations, the described techniques can be used to transmit PUCCH messages via relatively more antenna ports, which may increase an efficiency of communication resource use. Additionally, by aligning on a PUCCH codebook via indication of a PUCCH codebook ID, the described techniques may enable relatively improved coordination between devices. Further, using multiple antenna ports may result in lower bit error rates and higher signal metrics, such as signal to noise ratio, for PUCCH transmissions.

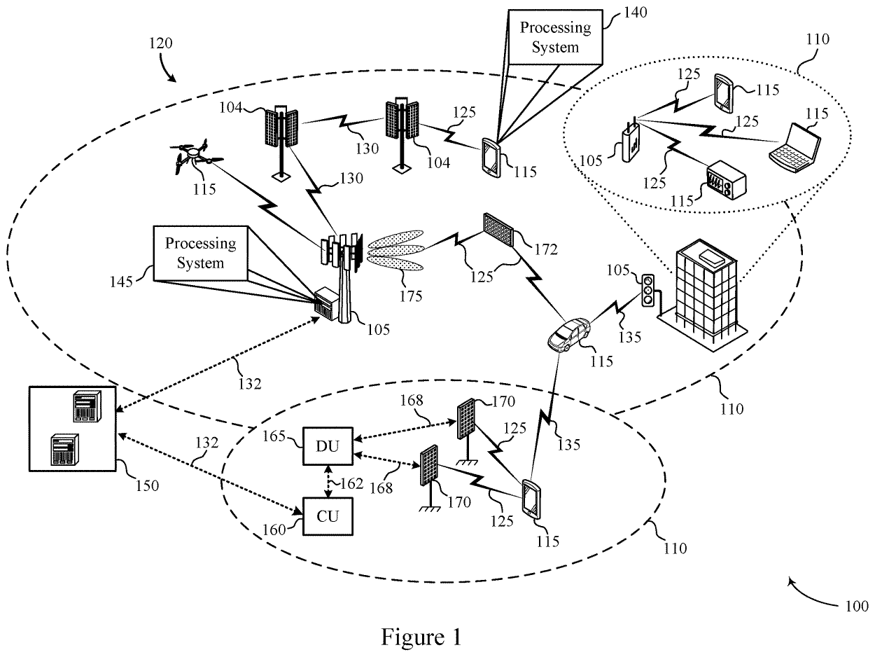

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communication to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communication of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a PUCCH for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communication (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some examples, AI/ML models may be deployed in one or more devices (e.g., network entities 105, UEs 115, or both) to enhance various aspects of the wireless communication system 100. Further, AI/ML models may be characterized in terms of types of learning that generate specific types of learned models that perform specific types of tasks. The wireless communication system 100 also may be configured to support human-brain interfacing which may refer to a communication interface between a human brain and an external device (e.g., a UE 115). For example, a human-brain interfacing device may monitor brain activity (e.g., electrical signals of a human-brain) to send signals and communicate with a respective external device. Further, such human-brain interfacing devices may communicate with wireless devices (e.g., UEs 115) via a communication link (e.g., a D2D communication link 135) and can be examples of wearable devices or devices that are directly connected to the human brain.

Devices of the wireless communication system 100 may be configured to support one or more aspects of the described techniques for PUCCH sequence switching based on network configurations. For example, a UE 115 may include a processing system 140, and a network entity 105 may include a processing system 145, each of which may be configured to cause the respective device to perform (such as being configured as means for performing) one or more of the described operations.

By configuring a processing system 140, a processing system 145, or a combination thereof in accordance with the described techniques, the wireless communication system 100 (such as the RAN 120) may support techniques for a UE 115 to wirelessly receive an indication of a PUCCH sequence codebook for the UE 115 to use in transmitting a PUCCH message to a network entity 105. For example, the UE 115 may wirelessly receive an indication of a PUCCH codebook ID associated with a PUCCH sequence codebook, and the UE 115 may transmit a PUCCH message with a sequence associated with the PUCCH codebook. Such techniques may enable relatively more efficient use of communication resources by dynamically indicating whether the UE 115 may transmit using a single antenna ports or multiple antenna ports. The described techniques may additionally enable relatively improved coordination between devices by enabling configuration of PUCCH codebooks that account for network configurations.

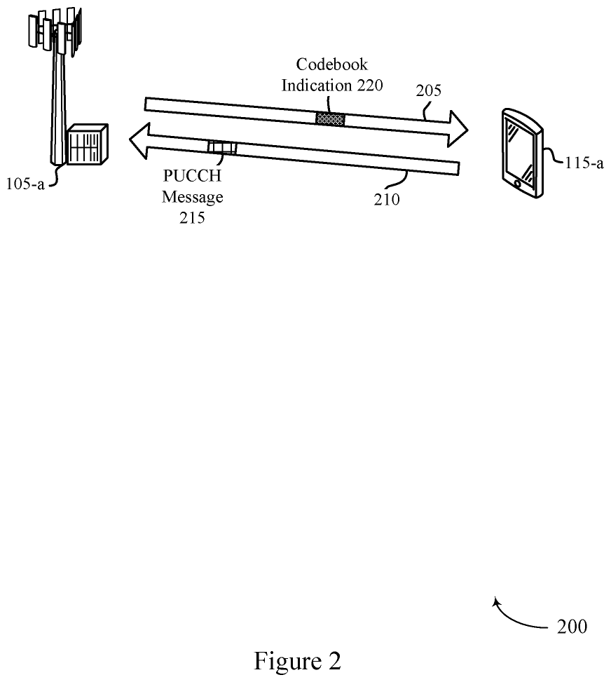

FIG. 2 shows an example of a signaling configuration 200 that supports PUCCH sequence switching based on network configurations. The signaling configuration 200 may implement or may be implemented by aspects of the wireless communication system 100. For example, the signaling configuration 200 may be implemented by a UE 115 (e.g., a UE 115-a) or a network entity 105 (e.g., a network entity 105-a), which may be examples of the corresponding devices as described with reference to FIG. 1.

In some examples of the signaling configuration 200, a UE 115-a may communicate with a network entity 105-a via an uplink channel 210. For example, the UE 115-a may transmit one or more PUCCH messages 215 via the uplink channel 210. In some examples, the PUCCH messages 215 may have a PUCCH format 0 and may span one resource block (RB) and one symbol (e.g., one OFDM symbol). The PUCCH message 215 may include one or more payload bits (e.g., up to 2 bits of HARQ-ACK and/or up to one bit indicating a positive or negative scheduling request (SR)).

In some examples (e.g., for PUCCH format 0), the PUCCH message 215 may include a sequence represented according to Equation 1.

$$x ( n ) = {e}^{j α n} * {e}^{j {φ}_{k} ( n ) π / 4} \qquad ( 1 )$$

As described with respect to Equation 1, e^{jαn} may represent a phase ramping parameter across one or more tones n (e.g., 12 tones, where 0≤n≤11) of the uplink channel 210, and α may be defined as a cyclic shift value, where α

$$∈ \frac{π}{6} .$$

{0, 1, 2, . . . , 11}. In some examples, e^{jφ}^{ₖ}^{(n)π/4} may represent a sequence (e.g., a computer-generated sequence), where k is a fixed value associated with a cell ID of the network entity 105-a, j is a complex value, and φ is a reception antenna port of the network entity 105-a. In some examples, the term e^{jαn} may be associated with inter-cell communication and may be transmitted using quadrature phase shift keying (QPSK), and the term e^{jφ}^{ₖ}^{(n)π/4} may be associated with inter- or intra-UE communication. Accordingly, for a given value of k, the UE 115-a may generate 12 potential 12-by-1 PUCCH sequences with different values of α. Each PUCCH sequence may be orthogonal to one or more other PUCCH sequences, which may prevent interference between PUCCH sequences.

In some examples, the UE 115-a may generate a PUCCH sequence based on a PUCCH codebook. The PUCCH codebook may include 2^{k}×2N_{f}Nₛ real values, where k is a quantity of information bits of the PUCCH message 215, N₃ is a quantity of transmission antenna ports of the UE 115-a, and N_{f} is a quantity of resource elements (REs) that the UE 115-a may transmit over per transmission antenna port of the UE 115-a (e.g., 12 REs for PUCCH format 0). For example, the UE 115-a may map each message vector of k bits (e.g., a vector comprising the k information bits of the PUCCH message 215, up to 3 information bits) to a respective codeword of N_{f}Nₛ complex numbers indicated by the PUCCH codebook (e.g., a complex number corresponding to each RE at each transmission antenna port of the UE 115-a). That is, for a quantity Nᵣ of reception antenna ports at the network entity 105-a that are configured to wirelessly receive the PUCCH message 215, a received PUCCH message 215 may be defined in a frequency domain as

$$Y [ : , j ] = {\sum }_{l = 0}^{{N}_{s}} H [ : , j , l ] ⊙ {S}_{i} [ : , l ] + N [ : , j ] ,$$

where the received signal is defined as Y∈ [symbol] ^{N}^{_{f}}^{×N}^{ᵣ}, the channel is defined as H∈ [symbol] ^{N}^{_{f}}^{×N}^{ᵣ}^{×N}^{ₛ}, the transmitted sequence is defined as Sᵢ∈ [symbol] ^{N}^{_{f}}^{×N}^{ₛ}, and a noise factor is defined as N∈ [symbol] ^{N}^{_{f}}^{×N}^{ᵣ}, where S∈{S₀, . . . S₂_{^{k}}₋₁}.

In some examples, to decode the PUCCH message 215, the network entity 105-a may perform non-coherent detection to compute a score corresponding to each sequence of the codebook

$${p}_{i} = {\sum }_{j = 0}^{{N}_{r}} {\sum }_{l = 0}^{{N}_{s}} {‖ {Y [ : , j ]}^{H} {S}_{i} [ : , l ] ‖}^{2} ∀ i ∈ \{ 0 , 1 , ... {2}^{k} - 1 \} .$$

The network entity 105-a may identify a sequence S_{i*} of the set of sequences that satisfies

$${i}^{*} = arg {max}_{i} {p}_{i}$$

(e.g., a sequence i* for which the score pᵢ is the highest), and may decode the symbol to be S_{i*}.

In some examples, the UE 115-a may wirelessly transmit the PUCCH message 215 via a single transmission antenna port of the UE 115-a (e.g., in examples in which the UE 115-a is configured with one available transmission antenna port or with multiple available transmission antenna ports). Accordingly, the UE 115-a may use fewer than an available quantity of transmission antenna ports to wirelessly transmit the PUCCH message 215, which may result in relatively less efficient allocation of resources. Additionally, if the UE 115-a transmits the PUCCH message 215 via multiple antenna ports, the UE 115-a may be unaware of whether to use a same PUCCH codebook for each antenna port or to use a different PUCCH codebook for each antenna port.

Accordingly, in some aspects, the UE 115-a may switch between multiple PUCCH codebooks based on a network configuration (e.g., a configuration of the UE 115-a, a configuration of the network entity 105-a). For example, the UE 115-a may wirelessly receive a codebook indication 220 that indicates PUCCH codebook ID. In some examples, the network entity 105-a may wirelessly transmit the codebook indication 220 via a downlink channel 205 upon establishing an initial connection to the UE 115-a (e.g., as part of an RRC or MAC-CE based network configuration). The UE 115-a may accordingly determine a PUCCH codebook in accordance with the codebook ID indicated by the network entity 105-a, and may use the PUCCH codebook to generate the PUCCH message 215.

In some examples, the network entity 105-a may select a PUCCH codebook based on one or more network configurations, such as a quantity of receive antennas configured to receive the PUCCH message 215 at the network entity 105-a, a carrier frequency over which the UE 115-a may wirelessly transmit the PUCCH message 215 (e.g., FR1 or FR3), a mode of transmission of the PUCCH message 215 (e.g., a TDD mode or an FDD mode), and the like.

In some examples, the PUCCH codebook ID may indicate whether the UE 115-a may use a one-port PUCCH codebook (e.g., a single port PUCCH codebook) or a multi-port PUCCH codebook. For example, the UE 115-a may select a codebook of a plurality of PUCCH codebooks associated with the indicated codebook ID. The plurality of PUCCH codebooks may include one or more single-port codebooks that the UE 115-a may use for single antenna port transmission of the PUCCH message 215 and one or more multi-port codebooks that the UE 115-a may use for multiple antenna port transmission of the PUCCH message 215. The codebook ID may accordingly indicate whether the UE 115-a may use single-port PUCCH transmission or multi-port PUCCH transmission. For example, if the indicated codebook ID is associated with single-port PUCCH transmission, the UE 115-a may use a single antenna port to wirelessly transmit the PUCCH message 215. If the indicated codebook ID is associated with multi-port PUCCH transmission, the UE 115-a may use multiple antenna ports to wirelessly transmit the PUCCH message 215.

Additionally, or alternatively, the plurality of PUCCH codebooks may include one or more DFT-based codebooks that the UE 115-a may use for generation of the PUCCH message 215 and one or more look-up table based codebooks that the UE 115-a may use for generation of the PUCCH message 215. The codebook ID may accordingly indicate whether the UE 115-a may use a DFT-based codebook or a look-up table (e.g., a look-up table indicating one or more AI or ML-based PUCCH sequences) for generation of the PUCCH message 215. For example, if the indicated codebook ID is DFT-based, the UE 115-a may use DFT-based information to generate the PUCCH message 215. If the indicated codebook ID is look-up table based, the UE 115-a may use information of the look-up table to generate the PUCCH message 215.

In some examples, the UE 115-a may be configured with one or more PUCCH codebooks (e.g., according to a rule defined in a technical specification or by wirelessly receiving a configuration message from one or more network entities 105 indicating the one or more PUCCH codebooks). In some examples, the UE 115-a may select the indicated PUCCH codebook from the one or more configured codebooks in response to receiving the ID. Additionally, or alternatively, the UE 115-a may not have access to (e.g., may not be configured with) the PUCCH codebook corresponding to the indicated codebook ID. In such examples, the UE 115-a may wirelessly transmit a request for the PUCCH codebook corresponding to the indicated codebook ID. For example, the UE 115-a may wirelessly transmit a request message to a server indicating the PUCCH codebook ID. The UE 115-a may wirelessly receive the indicated PUCCH codebook in response to indicating the PUCCH codebook ID to the server.

In some examples, for multi-antenna port transmissions, the UE 115-a may wirelessly transmit a same or different PUCCH sequence based on the indicated codebook and based on a quantity of reception antenna ports configured at the network entity 105-a for reception of the PUCCH message 215 (e.g., for DFT-based codebooks). For example, for a quantity of reception antennas Nᵣₓ=2, a bit error rate (BER) (e.g., a BER associated with a given signal-to-noise ratio (SNR)) may be relatively lower in examples in which the UE 115-a may wirelessly transmit different PUCCH sequences on each antenna port. For a quantity of reception antennas Nᵣₓ=8 or Nᵣₓ=16, a BER may be relatively lower in examples in which the UE 115-a may wirelessly transmit a same PUCCH sequence on each antenna port. Accordingly, in examples in which the network entity 105-a is configured with relatively more antenna ports (e.g., Nᵣₓ=8 or Nᵣₓ=16), the network entity 105-a may indicate, via the codebook ID, for the UE 115-a to use a multi-port DFT codebook that generates a different sequence for each antenna port.

In some examples, a look-up table based codebook may include sequences generated using AI or ML techniques, such as an ML model that is trained for different values of Nᵣₓ. Accordingly a look-up table based codebook that is indicated for relatively higher values of Nᵣₓ may be associated with sequences that are relatively more correlated as compared to a look-up table based codebook that is indicated for relatively lower values of Nᵣₓ. In some examples, an AI/ML based LUT may learn a 2^{k}×N_{f}Nₛ complex valued LUT by setting each element to have unit norm, for generating a set of sequences for a codebook. The described techniques may therefore increase a quality of communications based on dynamically configuring the UE 115-a to use a PDCCH codebook that is associated with a relatively lower BER based on network configuration.

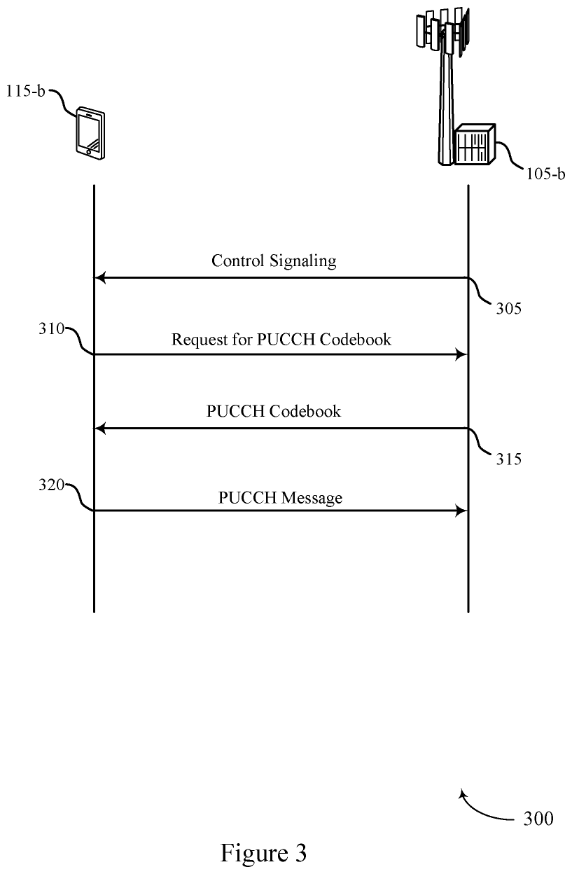

FIG. 3 shows an example of a process flow 300 that supports PUCCH sequence switching based on network configurations. The process flow 300 may implement or may be implemented by aspects of the wireless communication system 100 or the signaling configuration 200. For example, the process flow 300 may be implemented by a UE 115 (e.g., a UE 115-b) or a network entity 105 (e.g., a network entity 105-b), which may be examples of the corresponding devices as described with reference to FIG. 1.

In the following description of the process flow 300, the operations between the UE 115-b and the network entity 105-b may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the UE 115-b may wirelessly receive, from the network entity 105-b, control signaling that indicates a codebook ID associated with a first PUCCH codebook of a plurality of PUCCH codebooks for generation of PUCCH sequences for a PUCCH message. The control signaling may be RRC signaling, a MAC control element (CE), DCI, or the like. In some examples, the plurality of PUCCH codebooks may be configured at the UE 115-b. For example, the UE 115-b may wirelessly receive control signaling that configures the UE 115-b with the plurality of codebooks. Additionally, or alternatively, the plurality of codebooks may be defined according to a rule in a technical specification.

The plurality of PUCCH codebooks may include one or more codebooks that are associated with single antenna port PUCCH transmission, one or more codebooks that are associated with multiple antenna port PUCCH transmission, one or more DFT-based codebooks, and/or one or more codebooks associated with a look-up table of PUCCH sequences (e.g., ML-generated PUCCH sequences). Accordingly, the codebook ID may indicate for the UE 115-b to generate the PUCCH sequence using a single port PUCCH codebook or using a multi-port PUCCH codebook.

In some examples, the plurality of codebooks may be associated with one or more network conditions (e.g., a set of criteria). For example, the indicated PUCCH codebook associated with the codebook ID may be based on a quantity of antennas at the network entity 105-b that are configured for reception of the PUCCH message, a carrier frequency for transmission of the PUCCH message, a mode of transmission for the PUCCH message (e.g., FDD or TDD), and the like.

In some examples, at 310, the UE 115-b may wirelessly transmit a request for the PUCCH codebook associated with the indicated codebook ID. For example, if the UE 115-b does not have access to (e.g., is not configured with) the codebook associated with the indicated codebook ID, the UE 115-b may request the codebook from the network entity 105-b (or other device, such as a server). In such examples, at 315, the network entity 105-b (e.g., or the server) may wirelessly transmit a message to the UE 115-b that includes the PUCCH codebook associated with the codebook ID in response to the request.

At 320, the UE 115-b may wirelessly transmit the PUCCH message. For example, the UE 115-b may generate the PUCCH message in accordance with the codebook associated with the codebook identifier from the plurality of codebooks (e.g., using a PUCCH sequence of a set of PUCCH sequences of the indicated PUCCH codebook). The UE 115-b may wirelessly transmit the generated PUCCH message. In some examples, the UE 115-b may wirelessly transmit the generated PUCCH message using a quantity of transmission antenna ports indicated via the indication of the codebook ID. For example, in examples in which the codebook ID is associated with the single-port PUCCH codebook, the UE 115-b may wirelessly transmit the PUCCH message using a single antenna port. In examples in which the codebook ID is associated with the multi-port PUCCH codebook, the UE 115-b may wirelessly transmit the PUCCH message using multiple antenna ports.

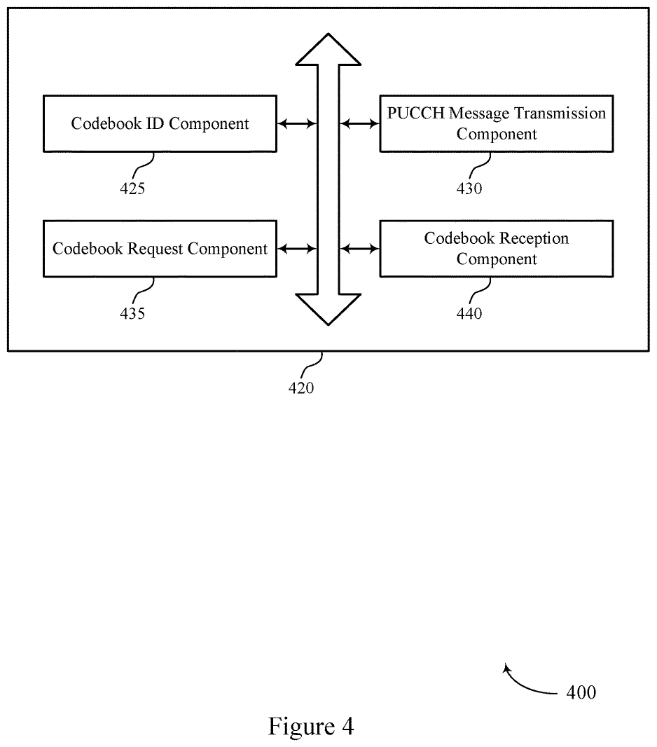

FIG. 4 shows an example of a processing system 420 that supports PUCCH sequence switching based on network configurations. A processing system 420 may be an example of a processing system 140 (such as of a UE 115) and may include a codebook ID component 425, a PUCCH message transmission component 430, a codebook request component 435, a codebook reception component 440, or any combination thereof. A processing system 420, or various component thereof, may be an example of means for performing (such as a means for causing a UE 115 to perform) various techniques described herein.

The codebook ID component 425 may be configured to cause the UE 115 to wirelessly receive control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. The PUCCH message transmission component 430 may be configured to cause the UE 115 to wirelessly transmit the PUCCH message generated in accordance with a first PUCCH sequence of the set of multiple PUCCH sequences of the first PUCCH codebook.

In some examples, the codebook request component 435 may be configured to cause the UE 115 to wirelessly transmit a request for the first PUCCH codebook based on reception of the codebook identifier. In some examples, the codebook reception component 440 may be configured to cause the UE 115 to wirelessly receive the first PUCCH codebook in response to the request.

In some examples, to support transmitting the PUCCH message, the PUCCH message transmission component 430 may be configured to cause the UE 115 to wirelessly transmit the PUCCH message via a single transmission antenna port of the UE in accordance with the first PUCCH codebook being associated with single antenna port PUCCH transmission.

In some examples, to support wirelessly transmitting the PUCCH message, the PUCCH message transmission component 430 may be configured to cause the UE 115 to wirelessly transmit the PUCCH message via multiple transmission antenna ports of the UE in accordance with the first PUCCH codebook being associated with multiple antenna port PUCCH transmission.

In some examples, the first PUCCH codebook is based on a quantity of antennas for reception of the PUCCH message, a carrier frequency for transmission of the PUCCH message, a mode of transmission of the PUCCH message, or any combination thereof.

In some examples, a mode of transmission of the PUCCH message is a time division duplex mode or a frequency division duplex mode.

In some examples, at least one of the set of multiple PUCCH codebooks is associated with discrete Fourier transform-based PUCCH sequences.

In some examples, at least one of the set of multiple PUCCH codebooks is associated with a look-up table of PUCCH sequences.

In some examples, the look-up table indicates a set of multiple machine learning-generated PUCCH sequences.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for selecting PUCCH codebooks for PUCCH sequences in accordance with network configurations, which may enable more efficient utilization of communication resources.

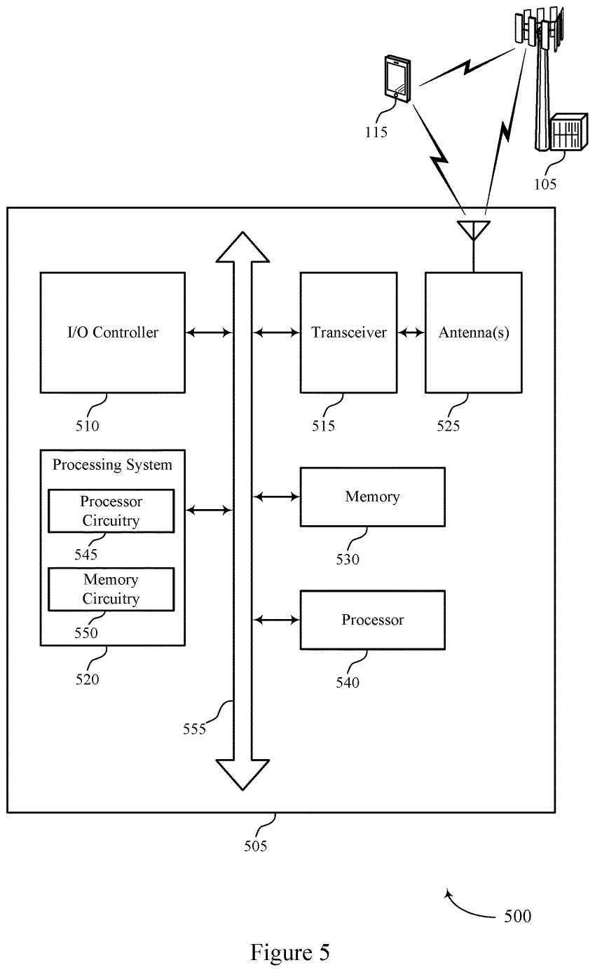

FIG. 5 shows an example of a system 500 including a device 505 that supports PUCCH sequence switching based on network configurations. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (110) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support PUCCH sequence switching based on network configurations. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for selecting PUCCH codebooks for PUCCH sequences in accordance with network configurations, which may enable reduced latency, more efficient utilization of communication resources, and improved coordination between devices.

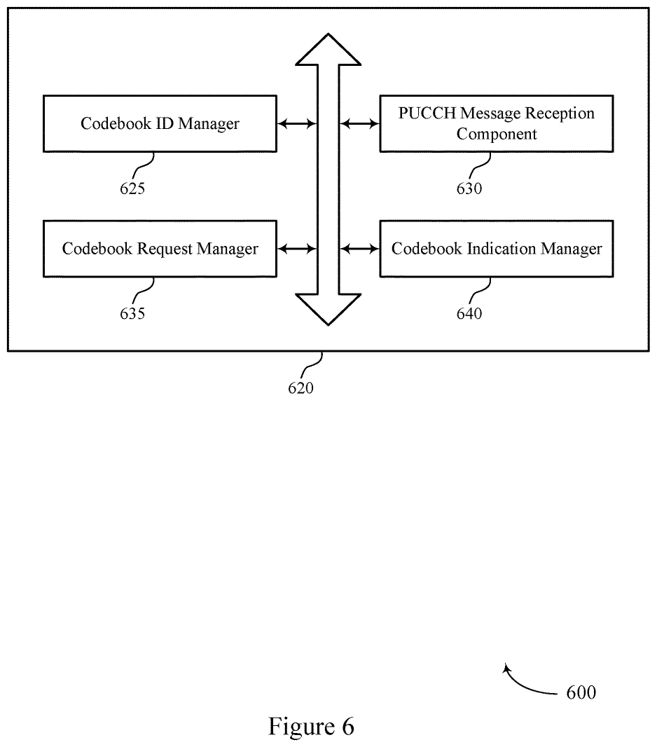

FIG. 6 shows an example of a processing system 620 that supports PUCCH sequence switching based on network configurations. A processing system 620 may be an example of a processing system 145 (such as network entity 105) and may include a codebook ID manager 625, a PUCCH message reception component 630, a codebook request manager 635, a codebook indication manager 640, or any combination thereof. A processing system 620, or various component thereof, may be an example of means for performing (such as a means for causing a network entity 105 to perform) various techniques described herein.

The codebook ID manager 625 may be configured to cause the network entity 105 to wirelessly transmit control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. The PUCCH message reception component 630 may be configured to cause the network entity 105 to wirelessly receive the PUCCH message generated in accordance with a first PUCCH sequence of the set of multiple PUCCH sequences of the first PUCCH codebook.

In some examples, the codebook request manager 635 may be configured to cause the network entity 105 to wirelessly receive a request for the first PUCCH codebook based on the codebook identifier. In some examples, the codebook indication manager 640 may be configured to cause the network entity 105 to wirelessly transmit the first PUCCH codebook in response to the request.

In some examples, to support wirelessly receiving the PUCCH message, the PUCCH message reception component 630 may be configured to cause the network entity 105 to wirelessly receive the PUCCH message via a single transmission antenna port in accordance with the first PUCCH codebook being associated with single antenna port PUCCH transmission.

In some examples, to support wirelessly receiving the PUCCH message, the PUCCH message reception component 630 may be configured to cause the network entity 105 to wirelessly receive the PUCCH message via multiple transmission antenna ports in accordance with the first PUCCH codebook being associated with multiple antenna port PUCCH transmission.

In some examples, the first PUCCH codebook is based on a quantity of antennas for reception of the PUCCH message, a carrier frequency for transmission of the PUCCH message, a mode of transmission of the PUCCH message, or any combination thereof.

In some examples, a mode of transmission of the PUCCH message is a time division duplex mode or a frequency division duplex mode.

In some examples, at least one of the set of multiple PUCCH codebooks is associated with discrete Fourier transform-based PUCCH sequences.

In some examples, at least one of the set of multiple PUCCH codebooks is associated with a look-up table of PUCCH sequences.

In some examples, the look-up table indicates a set of multiple machine learning-generated PUCCH sequences.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for selecting PUCCH codebooks for PUCCH sequences in accordance with network configurations, which may enable more efficient utilization of communication resources.

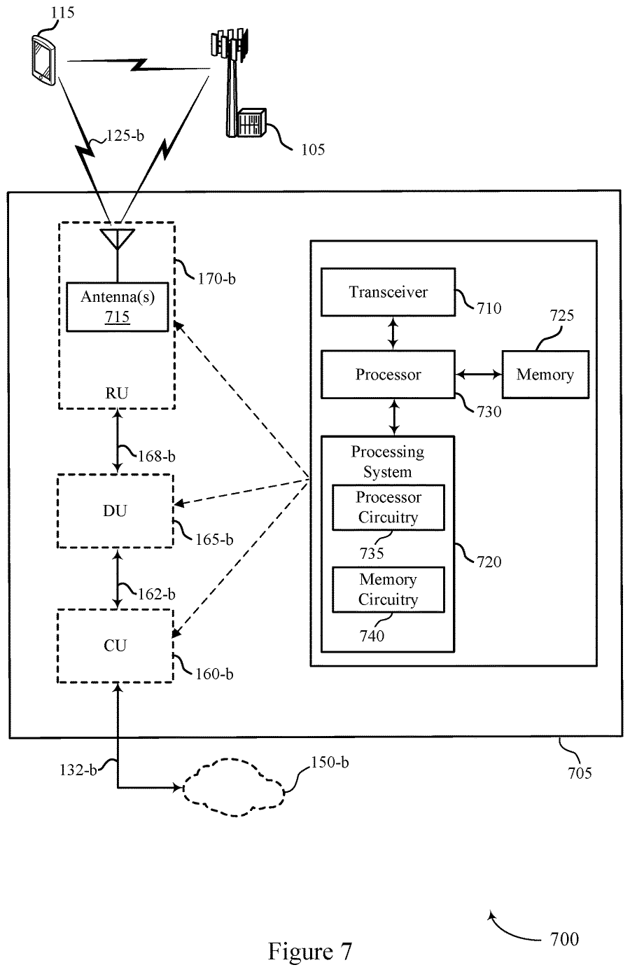

FIG. 7 shows an example of a system 700 including a device 705 that supports PUCCH sequence switching based on network configurations. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 600. For example, the processing system 720 may include processor circuitry 735 and memory circuitry 740 that stores code, and the processing system 720 may be configured to cause the device 705 to perform operations that support PUCCH sequence switching based on network configurations. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for selecting PUCCH codebooks for PUCCH sequences in accordance with network configurations, which may enable reduced latency, more efficient utilization of communication resources, and improved coordination between devices.

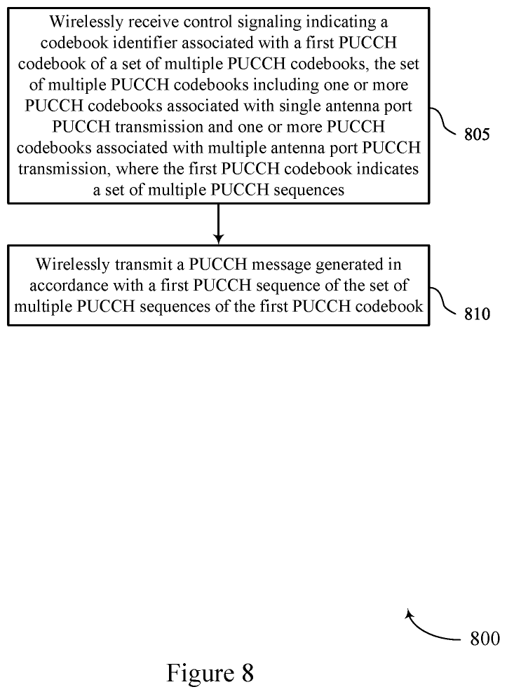

FIG. 8 shows an example of a method 800 that supports PUCCH sequence switching based on network configurations. Operations of the method 800 may be performed by a UE or its components (such as using a processing system configured to cause the UE 115 to perform one or more of the operations) as described herein.

At 805, the method may include wirelessly receiving control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. In some examples, aspects of the operations of 805 may be performed by a codebook ID component 425.

At 810, the method may include wirelessly transmitting the PUCCH message generated in accordance with a first PUCCH sequence of the set of multiple PUCCH sequences of the first PUCCH codebook. In some examples, aspects of the operations of 810 may be performed by a PUCCH message transmission component 430.

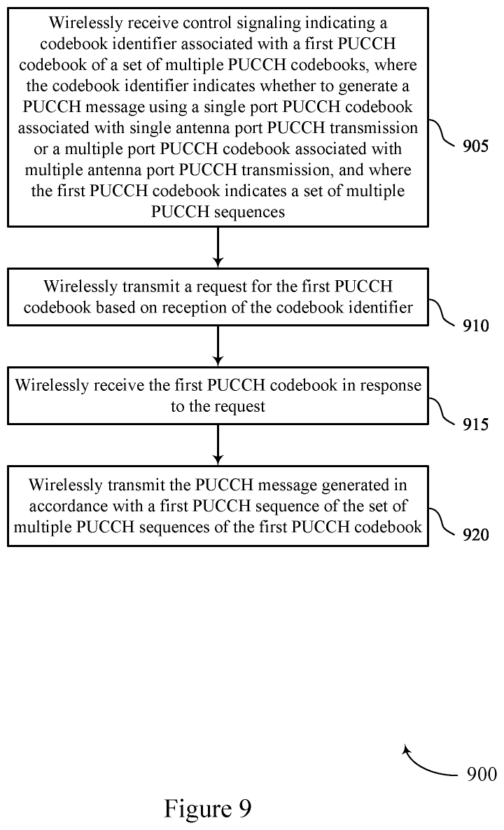

FIG. 9 shows an example of a method 900 that supports PUCCH sequence switching based on network configurations. Operations of the method 900 may be performed by a UE or its components (such as using a processing system configured to cause the UE 115 to perform one or more of the operations) as described herein.

At 905, the method may include wirelessly receiving control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. In some examples, aspects of the operations of 905 may be performed by a codebook ID component 425.

At 910, the method may include wirelessly transmitting a request for the first PUCCH codebook based on reception of the codebook identifier. In some examples, aspects of the operations of 910 may be performed by a codebook request component 435.

At 915, the method may include wirelessly receiving the first PUCCH codebook in response to the request. In some examples, aspects of the operations of 915 may be performed by a codebook reception component 440.

At 920, the method may include wirelessly transmitting the PUCCH message generated in accordance with a first PUCCH sequence of the set of multiple PUCCH sequences of the first PUCCH codebook. In some examples, aspects of the operations of 920 may be performed by a PUCCH message transmission component 430.

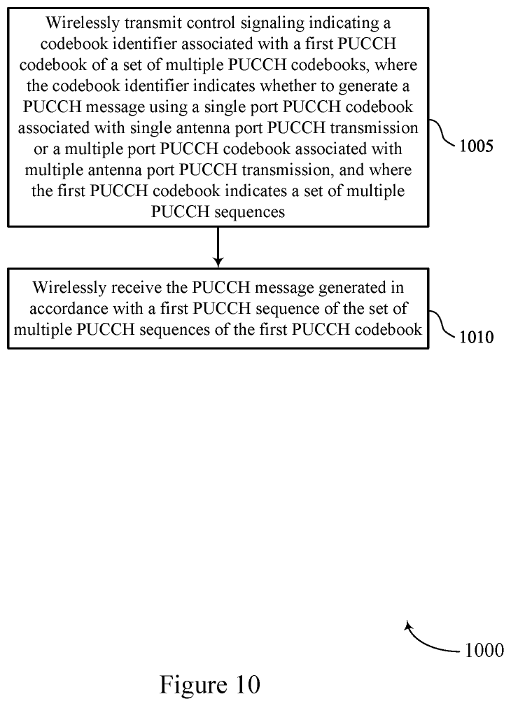

FIG. 10 shows an example of a method 1000 that supports PUCCH sequence switching based on network configurations. Operations of the method 1000 may be performed by a network entity 105 or its components (such as using a processing system configured to cause the network entity to perform one or more operations) as described herein.

At 1005, the method may include wirelessly transmitting control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. In some examples, aspects of the operations of 1005 may be performed by a codebook ID manager 625.

At 1010, the method may include wirelessly receiving the PUCCH message generated in accordance with a first PUCCH sequence of the set of multiple PUCCH sequences of the first PUCCH codebook. In some examples, aspects of the operations of 1010 may be performed by a PUCCH message reception component 630.

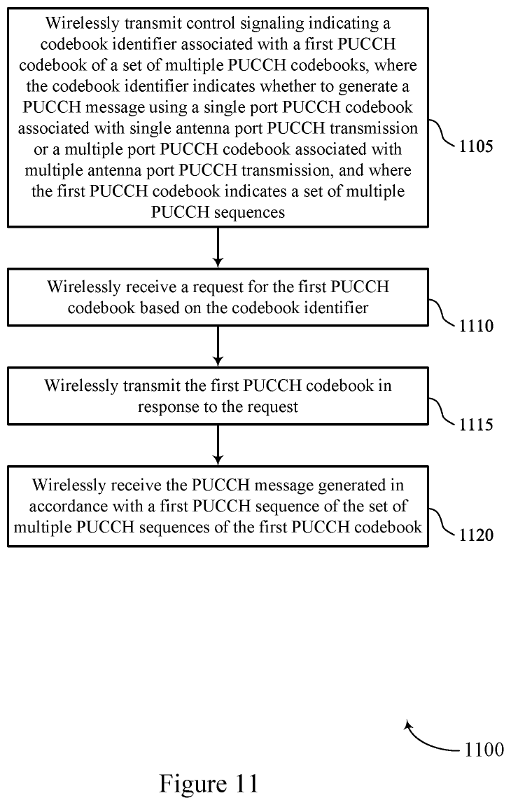

FIG. 11 shows an example of a method 1100 that supports PUCCH sequence switching based on network configurations. Operations of the method 1100 may be performed by a network entity 105 or its components (such as using a processing system configured to cause the network entity to perform one or more operations) as described herein.

At 1105, the method may include wirelessly transmitting control signaling indicating a codebook identifier associated with a first PUCCH codebook of a set of multiple PUCCH codebooks, where the codebook identifier indicates whether to generate a PUCCH message using a single port PUCCH codebook associated with single antenna port PUCCH transmission or a multiple port PUCCH codebook associated with multiple antenna port PUCCH transmission, and where the first PUCCH codebook indicates a set of multiple PUCCH sequences. In some examples, aspects of the operations of 1105 may be performed by a codebook ID manager 625.

At 1110, the method may include wirelessly receiving a request for the first PUCCH codebook based on the codebook identifier. In some examples, aspects of the operations of 1110 may be performed by a codebook request manager 635.

At 1115, the method may include wirelessly transmitting the first PUCCH codebook in response to the request. In some examples, aspects of the operations of 1115 may be performed by a codebook indication manager 640.

At 1120, the method may include wirelessly receiving the PUCCH message generated in accordance with a first PUCCH sequence of the set of multiple PUCCH sequences of the first PUCCH codebook. In some examples, aspects of the operations of 1120 may be performed by a PUCCH message reception component 630.

Implementation examples are described in the following numbered clauses:

Aspect 1: A method for wireless communication by a UE, comprising: wirelessly receiving control signaling indicating a codebook identifier associated with a first PUCCH codebook of a plurality of PUCCH codebooks, wherein the codebook identifier indicates whether to generate a PUCCH message using a single port PUCCH codebook associated with single antenna port PUCCH transmission or a multiple port PUCCH codebook associated with multiple antenna port PUCCH transmission, and wherein the first PUCCH codebook indicates a plurality of PUCCH sequences; and wirelessly transmitting the PUCCH message generated in accordance with a first PUCCH sequence of the plurality of PUCCH sequences of the first PUCCH codebook.

Aspect 2: The method of aspect 1, further comprising: wirelessly transmitting a request for the first PUCCH codebook based at least in part on reception of the codebook identifier; and wirelessly receiving the first PUCCH codebook in response to the request.

Aspect 3: The method of any of aspects 1 through 2, wherein wirelessly transmitting the PUCCH message further comprises: wirelessly transmitting the PUCCH message via a single transmission antenna port of the UE in accordance with the first PUCCH codebook being associated with single antenna port PUCCH transmission.

Aspect 4: The method of any of aspects 1 through 3, wherein wirelessly transmitting the PUCCH message further comprises: wirelessly transmitting the PUCCH message via multiple transmission antenna ports of the UE in accordance with the first PUCCH codebook being associated with multiple antenna port PUCCH transmission.

Aspect 5: The method of any of aspects 1 through 4, wherein the first PUCCH codebook is based at least in part on a quantity of antennas for reception of the PUCCH message, a carrier frequency for transmission of the PUCCH message, a mode of transmission of the PUCCH message, or any combination thereof.

Aspect 6: The method of aspect 5, wherein a mode of transmission of the PUCCH message is a time division duplex mode or a frequency division duplex mode.

Aspect 7: The method of any of aspects 1 through 6, wherein at least one of the plurality of PUCCH codebooks is associated with discrete Fourier transform-based PUCCH sequences.

Aspect 8: The method of aspect 7, wherein at least one of the plurality of PUCCH codebooks is associated with a look-up table of PUCCH sequences.

Aspect 9: The method of aspect 8, wherein the look-up table indicates a plurality of machine learning-generated PUCCH sequences.

Aspect 10: A method for wireless communication by a network entity, comprising: wirelessly transmitting control signaling indicating a codebook identifier associated with a first PUCCH codebook of a plurality of PUCCH codebooks, wherein the codebook identifier indicates whether to generate a PUCCH message using a single port PUCCH codebook associated with single antenna port PUCCH transmission or a multiple port PUCCH codebook associated with multiple antenna port PUCCH transmission, and wherein the first PUCCH codebook indicates a plurality of PUCCH sequences; and wirelessly receiving the PUCCH message generated in accordance with a first PUCCH sequence of the plurality of PUCCH sequences of the first PUCCH codebook.

Aspect 11: The method of aspect 10, further comprising: wirelessly receiving a request for the first PUCCH codebook based at least in part on the codebook identifier; and wirelessly transmitting the first PUCCH codebook in response to the request.

Aspect 12: The method of any of aspects 10 through 11, wherein wirelessly receiving the PUCCH message further comprises: wirelessly receiving the PUCCH message via a single transmission antenna port in accordance with the first PUCCH codebook being associated with single antenna port PUCCH transmission.

Aspect 13: The method of any of aspects 10 through 12, wherein wirelessly receiving the PUCCH message further comprises: wirelessly receiving the PUCCH message via multiple transmission antenna ports in accordance with the first PUCCH codebook being associated with multiple antenna port PUCCH transmission.

Aspect 14: The method of any of aspects 10 through 13, wherein the first PUCCH codebook is based at least in part on a quantity of antennas for reception of the PUCCH message, a carrier frequency for transmission of the PUCCH message, a mode of transmission of the PUCCH message, or any combination thereof.

Aspect 15: The method of aspect 14, wherein a mode of transmission of the PUCCH message is a time division duplex mode or a frequency division duplex mode.

Aspect 16: The method of any of aspects 10 through 15, wherein at least one of the plurality of PUCCH codebooks is associated with discrete Fourier transform-based PUCCH sequences.

Aspect 17: The method of aspect 16, wherein at least one of the plurality of PUCCH codebooks is associated with a look-up table of PUCCH sequences.

Aspect 18: The method of aspect 17, wherein the look-up table indicates a plurality of machine learning-generated PUCCH sequences.

Aspect 19: A UE for wireless communication, comprising a processing system that includes processor circuitry and memory circuitry that stores code, the processing system configured to cause the UE to perform a method of any of aspects 1 through 9.

Aspect 20: A UE for wireless communication, comprising at least one means for performing a method of any of aspects 1 through 9.

Aspect 21: A non-transitory computer-readable medium storing code for wireless communication, the code comprising instructions executable by one or more processors to perform a method of any of aspects 1 through 9.

Aspect 22: A network entity for wireless communication, comprising a processing system that includes processor circuitry and memory circuitry that stores code, the processing system configured to cause the network entity to perform a method of any of aspects 10 through 18.

Aspect 23: A network entity for wireless communication, comprising at least one means for performing a method of any of aspects 10 through 18.

Aspect 24: A non-transitory computer-readable medium storing code for wireless communication, the code comprising instructions executable by one or more processors to perform a method of any of aspects 10 through 18.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
wirelessly receive control signaling indicating a codebook identifier associated with a first physical uplink control channel (PUCCH) codebook of a plurality of PUCCH codebooks, wherein the codebook identifier indicates whether to generate a PUCCH message using a single port PUCCH codebook associated with single antenna port PUCCH transmission or a multiple port PUCCH codebook associated with multiple antenna port PUCCH transmission, and wherein the first PUCCH codebook indicates a plurality of PUCCH sequences; and
wirelessly transmit the PUCCH message generated in accordance with a first PUCCH sequence of the plurality of PUCCH sequences of the first PUCCH codebook.

2. The UE of claim 1, wherein the processing system is further configured to cause the UE to:
wirelessly transmit a request for the first PUCCH codebook based at least in part on reception of the codebook identifier; and
wirelessly receive the first PUCCH codebook in response to the request.

3. The UE of claim 1, wherein, to transmit the PUCCH message, the processing system is further configured to cause the UE to:
wirelessly transmit the PUCCH message via a single transmission antenna port of the UE in accordance with the first PUCCH codebook being associated with single antenna port PUCCH transmission.

4. The UE of claim 1, wherein, to wirelessly transmit the PUCCH message, the processing system is further configured to cause the UE to:
wirelessly transmit the PUCCH message via multiple transmission antenna ports of the UE in accordance with the first PUCCH codebook being associated with multiple antenna port PUCCH transmission.

5. The UE of claim 1, wherein the first PUCCH codebook is based at least in part on a quantity of antennas for reception of the PUCCH message, a carrier frequency for transmission of the PUCCH message, a mode of transmission of the PUCCH message, or any combination thereof.

6. The UE of claim 5, wherein a mode of transmission of the PUCCH message is a time division duplex mode or a frequency division duplex mode.

7. The UE of claim 1, wherein:
at least one of the plurality of PUCCH codebooks is associated with discrete Fourier transform-based PUCCH sequences.

8. The UE of claim 7, wherein at least one of the plurality of PUCCH codebooks is associated with a look-up table of PUCCH sequences.

9. The UE of claim 8, wherein the look-up table indicates a plurality of machine learning-generated PUCCH sequences.

10. A network entity, comprising:
a processing system that includes processor circuitry and memory circuitry that stores code, the processing system configured to cause the network entity to:
wirelessly transmit control signaling indicating a codebook identifier associated with a first physical uplink control channel (PUCCH) codebook of a plurality of PUCCH codebooks, wherein the codebook identifier indicates whether to generate a PUCCH message using a single port PUCCH codebook associated with single antenna port PUCCH transmission or a multiple port PUCCH codebook associated with multiple antenna port PUCCH transmission, and wherein the first PUCCH codebook indicates a plurality of PUCCH sequences; and
wirelessly receive the PUCCH message generated in accordance with a first PUCCH sequence of the plurality of PUCCH sequences of the first PUCCH codebook.

11. The network entity of claim 10, wherein the processing system is further configured to cause the network entity to:
wirelessly receive a request for the first PUCCH codebook based at least in part on the codebook identifier; and
wirelessly transmit the first PUCCH codebook in response to the request.

12. The network entity of claim 10, wherein, to wirelessly receive the PUCCH message, the processing system is further configured to cause the network entity to:
wirelessly receive the PUCCH message via a single transmission antenna port in accordance with the first PUCCH codebook being associated with single antenna port PUCCH transmission.

13. The network entity of claim 10, wherein, to wirelessly receive the PUCCH message, the processing system is further configured to cause the network entity to:
wirelessly receive the PUCCH message via multiple transmission antenna ports in accordance with the first PUCCH codebook being associated with multiple antenna port PUCCH transmission.

14. The network entity of claim 10, wherein the first PUCCH codebook is based at least in part on a quantity of antennas for reception of the PUCCH message, a carrier frequency for transmission of the PUCCH message, a mode of transmission of the PUCCH message, or any combination thereof.

15. The network entity of claim 14, wherein a mode of transmission of the PUCCH message is a time division duplex mode or a frequency division duplex mode.

16. The network entity of claim 10, wherein:
at least one of the plurality of PUCCH codebooks is associated with discrete Fourier transform-based PUCCH sequences.

17. The network entity of claim 16, wherein at least one of the plurality of PUCCH codebooks is associated with a look-up table of PUCCH sequences.

18. The network entity of claim 17, wherein the look-up table indicates a plurality of machine learning-generated PUCCH sequences.

19. A method for wireless communication by a user equipment (UE), comprising:
wirelessly receiving control signaling indicating a codebook identifier associated with a first physical uplink control channel (PUCCH) codebook of a plurality of PUCCH codebooks, wherein the codebook identifier indicates whether to generate a PUCCH message using a single port PUCCH codebook associated with single antenna port PUCCH transmission or a multiple port PUCCH codebook associated with multiple antenna port PUCCH transmission, and wherein the first PUCCH codebook indicates a plurality of PUCCH sequences; and
wirelessly transmitting the PUCCH message generated in accordance with a first PUCCH sequence of the plurality of PUCCH sequences of the first PUCCH codebook.

20. The method of claim 19, further comprising:
wirelessly transmitting a request for the first PUCCH codebook based at least in part on reception of the codebook identifier; and
wirelessly receiving the first PUCCH codebook in response to the request.
